(19) United States
(12) Patent Application Publication
(10) Pub. No.: US 2007/0022106 A1
(43) Pub. Date: Jan. 25, 2007

(54) System design using a RAS-based database

(75) Inventors: Wayne D. Brandt, Morton, IL (US); Walter E. Earleson, Morton, IL (US); Dale B. Herget, Mapleton, IL (US); Wayne J. Wulfert, East Peoria, IL (US); Vernon Richard Smith, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/185,731

(22) Filed: Jul. 21, 2005

(51) Int. Cl. G06F 17/30

(52) U.S. Cl. 707/4

(57) ABSTRACT

A system design environment includes a Reusable Asset Specification (“RAS”) based database including information related to hardware components. The design environment may also include a controller. The controller may be configured to accept a user input including at least one desired system parameter. The controller may also be configured to identify from the RAS based database at least one hardware component that contributes to satisfaction of the desired system parameter. The controller may be further configured to output a specification for a system including the at least one hardware component.

### TECHNICAL FIELD

The present disclosure is directed to the field of designing a system using a software-based design environment and, more particularly, to a software-based design environment using a Reusable Asset Specification (“RAS”) based database.

### BACKGROUND

Various types of design environments may be used to develop systems including software and hardware systems. Many of these design environments include the use of a function-based approach towards the development of these systems. For example, a user may input a plurality of sub-functions that a system may have to perform in order to perform the overall desired function of the system. The input may also indicate the interaction between the sub-functions. The design environment may include a design tool configured to identify, from a database, components available to the design tool for building the system that may perform the functions desired by the user.

The database, including components available for use in the design of the system, serves an important function. A number of the components available from the database may be capable of being reused in one form or another. Various groups within an enterprise may be working on similar projects, and components developed by one group for a project may be apt to be used by a different group working on another project. This reusability of components may lead to reduction in resource costs, expenses, and development time for a project.

While some components may be reused “as is”, others may be reused with some modifications. It is therefore helpful to have a database that not only stores these components or information relating to these components, but also provides the design environment with enough information pertaining to the reusability of each component. However, identifying components that are available for reuse for a particular function may be a complicated task.

A number of systems have been developed to manage reusable components. Many of these systems include information about a component that is specific to the design environment in which the component was developed. Because of this, the database used in that design environment may include only components that are specific to the design environment in which the database is being used.

An example of one such system is disclosed in U.S. Patent Application No. 2003/0046282 by Carlson et al. (“the '282 application”), which published on Mar. 6, 2003. The '282 application discloses systems for the reuse of software components in an enterprise. In particular, the '282 application discloses a system for storing software components in repositories. Asset sources may then be used to describe the components as developed and also describe them in a form conforming to a data description language. The data description language describes the format, structure, and organization of the component. An asset management system may be configured to collect these component descriptions and publish them in a searchable format for a user.

While the system of the '282 application may help capture and manage reusable software, it includes several shortcomings. For example, while this system discloses how to categorize and use software components, it does not disclose a system of storing tangible components that are not software based. Further, while the system of the '282 application may be capable of storing components developed by an enterprise, the system does not use a standard format to describe the stored components and, thus, lacks the capability of storing components manufactured by parties unrelated to the user. This lack of standardization of the database may prevent the addition of components made by different manufacturers in the same database. This may limit the number of components that may be stored in a database, which in turn may limit the options available to a design environment that is configured to use the database.

The present disclosure is directed to overcoming one or more of the problems of the existing reusable component management systems.

### SUMMARY OF THE INVENTION

One aspect of the present disclosure includes a system design environment. The design environment may include a Reusable Asset Specification (“RAS”) based database including information related to hardware components. The design environment may also include a controller. The controller may be configured to accept a user input including at least one desired system parameter. The controller may also be configured to identify from the RAS based database at least one hardware component that contributes to satisfaction of the desired system parameter. The controller may be further configured to output a specification for a system including the at least one hardware component.

Another aspect of the present disclosure includes a method for designing a system. The method may include accepting a user input including at least one desired system parameter. The method may further include accessing a Reusable Asset Specification (“RAS”) database including hardware component information. The method may also include identifying, from the RAS database, at least one hardware component that contributes to satisfaction of the desired system parameter. The method may also include outputting a specification for a system including the at least one hardware component.

### BRIEF DESCRIPTION OF THE DRAWINGS

FIG. 1 is a block diagram representation of a system design environment using a RAS based database according to an exemplary disclosed embodiment.

FIG. 2 is a block diagram representation of a RAS based catalog asset profile distribution according to an exemplary disclosed embodiment.

FIG. 3 is a block diagram representation of a RAS based profile according to an exemplary disclosed embodiment.

### DETAILED DESCRIPTION

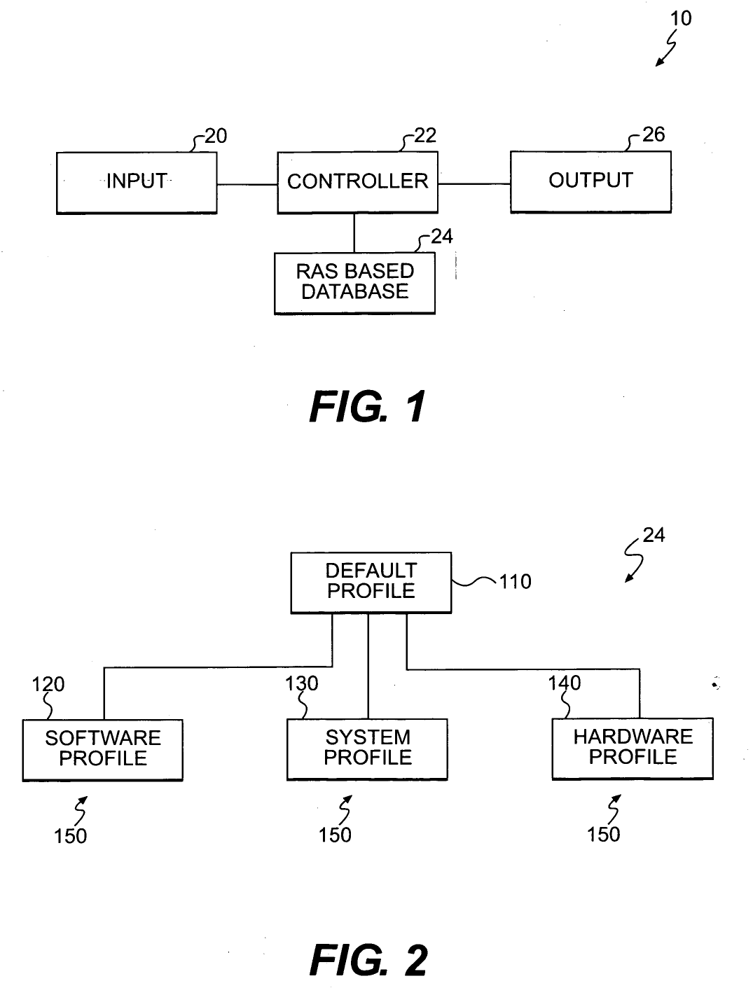

FIG. 1 provides a block diagram representation of a system design environment 10. Design environment 10 may include an input device 20, a controller 22, a RAS based database 24, and an output device 26.

Controller 22 may be configured to receive an input from a user through input device 20. This input may include at least one system parameter desired by a user. The system parameter may be part of a system the user may want to design based on certain functions that the user desires the system to perform. For example, a user may want to design a work machine such as a track-type tractor that includes an engine with a certain horsepower rating, a transmission with certain characteristics (e.g., automatic, manual etc.), wheels of a certain size, a bucket of a certain size, etc. These characteristics of the engine, transmission, wheels, bucket, etc. may correspond to the system parameters desired by the user for the work machine system. A variety of hardware, software, and system components may be used to build a system that satisfies these system parameters. These components or information relating to these components may be stored in RAS based database 24. Based on an input received through input device 20, controller 22 may identify components from RAS based database 24 that may be used to satisfy the system parameters desired by the user. Controller 22 may then use the identified components to form an output, which may include a specification for a system desired by the user. The specification may include hardware that may be used to build the system as per the desired system parameters and/or software that may be used to operate the hardware that exhibits the desired system parameters.

RAS based database 24 may include various kinds of components or information relating to the components that may be used to develop a system using system design environment 10. These components may include software and/or tangible components. The tangible components may include hardware components that may be used to develop a system using system design environment 10.

The component information (and in some cases the components themselves, e.g., when the components include software etc.) may be stored in RAS based database 24 as a library of objects. While stored in database 24 as an object, information associated with each component may also include data associated with it that may describe and represent the component. For example, a software component may have a piece of code associated with the software that may represent it as a block diagram to the user, once the software component is selected by controller 20. If the piece of software component accepts two inputs and produces one output, the block diagram may also include, for example, two input terminals and one output terminal. The code associated with the software may also include user help information for a user to learn about the software component. Similarly, if RAS based database 24 is configured to store information about a hardware component, then along with information about the hardware component, database 24 may also include information that presents a graphical representation of the hardware component to the user.

It may be desirable, for example, to describe and categorize all of the components in RAS based database 24 for use in a manner such that controller 22 may easily identify these components. Furthermore, because the components in RAS based database 24 may be used in the development of different systems, such components may be described and/or stored in RAS based database 24 in a manner that promotes the reusability of the component. RAS permits a user to collect all the relevant information about a component (also known as an “asset” in RAS terminology) and present that information in a form that may promote the reusability of the component as an asset.

In RAS terminology, a database including assets described as per RAS may be known as a catalog. A RAS based catalog may use a method to categorize assets in the catalog based on some common attributes that may exist within a group of assets. One such method is to categorize assets in a RAS catalog using profiles. A profile may include a group of assets that may share a set of common attributes. Because of the use of profiles to categorize assets in a RAS catalog, every asset in a RAS catalog may be part of at least one profile. A RAS based database may, therefore, include at least one default profile and at least one or more related profiles.

FIG. 2 is a representation of RAS based database 24 including a default profile 110 and one or more related profiles 150 including a software profile 120, a system profile 130, and a hardware profile 140. Related profiles 150 may be derived from default profile 110.

Default profile 110 may include certain attributes that are common to all assets. This profile may be obtained from an industry standard default profile. For example, a default RAS profile that may be used in any industry is freely available. From this freely available default profile, an entity may configure a default profile of its own.

Default profile 110 may include the minimum set of data about an asset. This minimum data set may then be applied to all the related profiles. For example, a default profile may include information such as, for example, that the asset belongs to the firm that developed the asset. Furthermore, an asset developed or obtained by a firm that may not be categorized into one of the related profiles may have all its information stored in default profile 110.

A related profile may be created from default profile 110. A related profile may be created to add tighter semantics and constraints to default profile 110. These semantics and constraints may add information about an asset in addition to that contained in default profile 110 about that asset. However, limitations placed on an asset by default profile 110 of the asset may not be reduced in the related profile. Thus, a related profile may only add to information about an asset that was included in default profile 110 and may not reduce or change the information stored in default profile 110. For example, a related profile may make some attributes required, which were optional in default profile 110. However, the constraints in default profile 110 may not be removed.

As represented by FIG. 2, software profile 120 may be derived from default profile 110. Software profile 120 may be configured to store information related to an asset, which may be in addition to the information related to that asset, that is stored in default profile 110 For example, if the asset is a software program, default profile 110 may include information about the general attributes of the software, e.g., the manufacturer and/or the name of the software. This information may be very basic. It may not include information that the asset is actually a software program. On the other hand, software profile 120 may include information that informs controller 22 and a user that this asset is a software program. For example, the additional information may be that the asset is a software program used for regeneration of a particulate trap. In addition, software profile 120 may also include other information pertaining to the piece of software that is specific to a software asset. This includes, for example, the language in which the software was written. It should be noted, however, that software profile 120 may not remove any information about an asset that is part of the asset's default profile 110.

System profile 130 may include information pertaining to an asset if the asset is a part of a system. For example, if a piece of software is an asset that is part of a wheel drive system, information describing the software as part of the wheel drive system may be stored in the system profile.

Any number of profiles may be developed from the default profile. In addition to software profile 120 and system profile 130, a hardware profile 140 for hardware components may be developed from default profile 110. The hardware profile may inherit all the limitations from default profile 110, but may include additional information specific to hardware components. For example, if a controller is used for regeneration of a particulate trap, basic information about the controller such as, for example, the name of the firm that is using the controller may be included in default profile 110. Information specific to the hardware of the controller may be included in hardware profile 140. For example, information about the type of memory chips used in the hardware (DRAM, SDRAM, SRAM etc.), the type of processor chip used in the controller (IC, ASIC etc.), and other such information may be included in hardware profile 140 of the controller. In addition, other related profiles (not shown) may be developed from default profile 110.

In an exemplary embodiment, a hardware profile and a software profile may be developed from a system profile. For example, if a pressure sensor system (system asset) includes pressure sensors (hardware asset) and software used to operate the pressure sensors (software asset), then general information about the pressure sensor system (e.g., on what kind of machines the system may operate etc.) may be included in a system profile. However, information pertaining to the specifics of the software operating on the pressure sensor system (e.g., version of software, language in which it was developed, etc.) may be included in a software profile that is related to the system profile. Similarly, information specific to the hardware of the pressure sensors (e.g., type of sensor, information about mechanics of the sensor, etc.) may be included in a hardware profile that is related to the system profile.

While all the assets may be categorized into different profiles, each asset may also be made of discrete artifacts. An artifact is part of an asset. For example, a software asset may include multiple software files that are combined together to form the software asset. These software files that may be combined together to form a software asset may be known as artifacts. Similarly, a hardware asset may be made up of a number of artifacts. For example, a controller may include a CPU, memory, input interface, output interface etc., each of which may be known as an artifact. The collection of discrete artifacts in an asset may be numerous. There may, therefore, be a need to specify how the artifacts in an asset are organized and which pieces of information describing the asset may be required. RAS helps by specifying how the artifacts are organized in an asset.

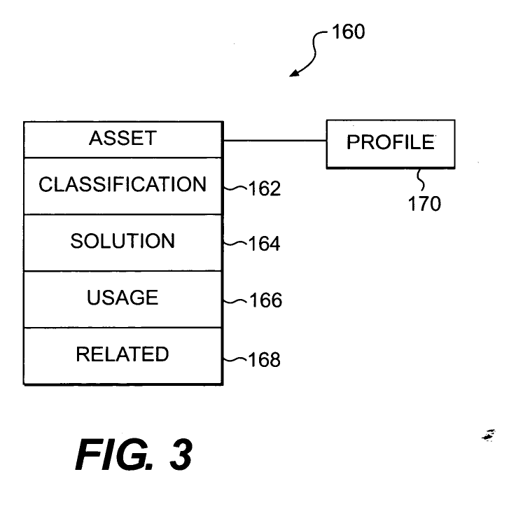

FIG. 3 represents major sections of a RAS based asset 160. Asset 160 may include a software asset, a hardware asset, or any other asset known in the art. Furthermore, asset 160 may belong to a profile 170. Asset 160 may include at least a classification section 162, a solution section 164, a usage section 166, and a related section 168.

Classification section 162 may include information that may help a user determine what broad field of use asset 160 may be classified in. For example, an asset used in transmission systems may be classified under class “transmission systems”, an asset used in switching systems may be classified under class “switching systems”, etc. Solution section 164 may include information about the various artifacts that form asset 160. This information may include data about the type of the artifact (e.g., software files, hardware chips, etc.), the development costs of the artifact, etc. Usage section 166 may include information that may help a user understand how to use asset 160. This includes, for example, how to customize asset 160 for use in a particular application, how to install asset 160, etc. Related section 168 may include information about other assets related to asset 160.

Classification section 162 may include descriptors about asset 160. These descriptors may include a short description of the various domains asset 160 may be used in. This information in the descriptors may be relevant to the classification of asset 160 and may be useful for searching for reusable assets. In an exemplary embodiment, asset 160 may be described in descriptors using name/value pairs. By using a name/value pair, a descriptor may include the domain in which asset 160 may be used. For example a software asset may be used in “domain transmission” and/or in “domain engine.”

If a software asset is classified in a name/value pair as a “domain transmission”, the name portion of the name/value pair is “domain” and the value portion is “transmission.” This description may provide a user with a general idea of the use of the software asset. For example, a software asset with a name/value pair of “domain transmission” may be appropriate for use in a transmission system. When a search including keywords “software+transmission” is performed, a list of name/value pairs describing assets that match those keywords may be displayed. One of the name/value pairs in the list may include “domain transmission.” In addition to domain “transmission,” other name/value pairs may be used in descriptors. In another example, if the asset is a piece of hardware, for example, “engine controller 1,” then the asset may be described using a name value pair of “domain natural-gas” indicating that engine controller 1 may be used in a natural-gas engine system.

In addition to descriptors, classification section 162 may also include a short statement of the problem an asset may be configured to solve. This problem statement may also include a synopsis of how the asset may solve the particular problem. For example, the problem statement in a classification section of engine controller 1 may include what kind of functions engine controller 1 may perform (e.g., vibration control, regeneration control etc.).

Classification section 162 may also include a context for which asset 160 is relevant. Based on information stored in solution section 164 and usage section 168, classification section 162 may declare a specific context for which the asset is relevant. For example, if a software asset is developed to operate on any piece of hardware, i.e., it is hardware independent, then the software asset may be placed in a “general” context. On the other hand, if the piece of software is configured to operate on specific hardware, e.g., natural-gas controller, then the software asset may be placed in a “natural-gas” context. Similarly if a piece of hardware may be used in a generic class of machines, it may be classified in a “general context”. However, if the hardware may only be used on a specific machine, e.g. track-type tractor, then it may be placed in a specific context pertaining to a track type tractor. This includes, for example, “track-type tractor” context. Other contexts such as a development context and an implementation context may be defined to classify artifacts in asset 160.

In addition to descriptors and problem statements, other fields may also be added to classification section 162 in order to provide for more granularity in classifying asset 160. For example, a field indicating the level of reusability (i.e., full reusability, partial reusability etc.) may be included in classification section 162. Furthermore, based on the attributes of assets used in an enterprise, a hierarchy field may be added to classification section 162. In addition, other information that may be helpful in classifying asset 160 may be included in classification section 162.

Solution section 164 may describe the various artifacts used in asset 160. These artifacts may include hardware and software components. If the artifact is a piece of software, then solution section 164 may include the artifact itself or a pointer to where the artifact is stored. If the artifact is a piece of hardware, then information pertaining to the hardware may be stored in this section. In addition, the section may include the development cost of the artifacts and the requirements a system may need to meet in order to use the artifact.

If asset 160 is a software asset that includes, for example, three C files, then solution section 164 may include the C files themselves or a pointer to a location that holds the C files. Solution section 164 may also include test results obtained by the developer while developing the software, code used to display the software as an object on a GUI for a user, and help files for the software. In addition, solution section 164 may include other information pertaining to the software such as, for example, location of a software file, etc.

If asset 160 includes hardware artifacts, then solution section 164 may include all the information relevant to the hardware artifacts. This information may include the part number, the list of sub-components used to manufacture the hardware, code used to display the piece of hardware as an object on a GUI for a user, the kinds of systems the hardware may be used in (e.g., a high-way truck, track type tractor, wheel loader, etc.), and the kinds of electronic control units with which the hardware may be compatible. In addition, solution section 164 may also include information about any minimum system requirements the system using the hardware may need to meet, in order to use the hardware. Solution section 164 may include other information pertaining to the hardware. If asset 160 is a regeneration controller, the artifacts that constitute asset 160 may include a memory, a CPU, an input port, an output port, and other artifacts. Solution section 164 may therefore include information about these artifacts. For example, solution section 164 may include information about the type of memory (e.g., DRAM, SDRAM, SRAM, etc.), the type of CPU (e.g., CPU speed, power rating, etc.), and the types of input/output ports (e.g., twisted pair ports, optical fiber ports, wireless ports, etc.). In addition, solution section 164 may include other appropriate information for asset 160.

Solution section 164 may also include information about how the artifact was developed by the user. For example, solution section 164 may include the development cost of the artifact. The development cost may include the number of hours spent in developing the artifact. In addition, other appropriate information regarding the development of the artifact may be included in solution section 164.

Usage section 166 may include the rules for installing, customizing and using asset 160. Furthermore, usage section 166 may also include information about the reusage cost of asset 160. These pieces of information may assist a user in reusing asset 160 more efficiently. Thus, for example, if asset 160 is a software asset, usage section 166 may include information about whether the software may be installed on a given operating system (e.g., Windows, UNIX, LINUX, etc.). Usage section 166 may also include any system requirements for running the software. These include, for example, the minimum memory and CPU requirements for running the software, etc. Usage section 166 may also include information about the requirements for reusing asset 160. For example, it may indicate those portions of asset 160 that may need to be modified in order to use asset 160 effectively for a given application. In addition, the estimated reusage cost for reusing asset 160 may be included in usage section 166. This reusage cost may be stated in units of hours. For example, the section may indicate that twenty hours may be needed to modify asset 160 to effectively reuse it in a given application. In addition, usage section 166 may include other information that may assist a user in reusing asset 160 such as, for example, customer base, access rights, etc.

Related section 168 may include information that may describe the relationship asset 160 may have with other assets (not shown). For example, if asset 160 is a regeneration controller for a work machine, there may be other assets that are related to a regeneration controller. One such asset may include, for example, a regeneration device. Related section 168 for the regeneration controller may include a reference to the regeneration device because it is related in function to the regeneration controller. Use of related section 168 is beneficial because when asset 160 is displayed to a user for potential use, other assets that have a relationship with asset 160, and are described in related section 168, may also be displayed to the user for possible use. This feature may aid a user in designing a system because he may now be aware of assets that he may not have been aware of earlier, but that relate to the design parameter he desires.

It should be noted that while this invention discloses asset 160 as including the classification 162, solution 164, usage 166, and related 168 sections, other sections that may be developed as part of the RAS may also be used in addition to those disclosed.

RAS based database 24 may be developed using a number of programming languages. For example, RAS based database 24 may be developed using Extensible Markup Language (“XML”) wherein a XML schema may be used to describe the components stored in RAS based database 24. In addition, other languages that may be used to structure, store, and send data may be used to develop RAS based database 24. It should be noted that while RAS based database 24 may be developed using XML, the software components and other code whose information is included in RAS based database 24 may be written in any language such as C, C++, Visual Basic, etc.

RAS based database 24 may be configured to be stored on hardware that is appropriate for running a RAS based database. For example, RAS based database 24 may be configured to operate on servers. Alternatively, other hardware suitable to store a RAS database may be used to store RAS based database 24.

Referring back to FIG. 1, input device 20 may exist in various forms. For example, a floppy drive may be used as input device 20, wherein a file including the desired system parameters may be stored on a floppy disk which is loaded in the floppy drive. Alternatively, a CD drive or a DVD drive may be used as input device 20, wherein a file including the desired system parameters may be stored on a CD or a DVD, respectively. In another instance, a keyboard (not shown) may be used as input device 20. In addition, other suitable forms of input devices may be used as input device 20.

Controller 22 may be configured to receive the desired system parameters from input device 20, determine the assets that may be used from RAS based database 24, form a system specification that includes the system parameters, and output the specification through output device 26. Controller 22 may perform these tasks by using a software program. In an exemplary embodiment, a system design tool may be used as a software program by controller 22 to perform these tasks. The system design tool may be developed using Java running on an Eclipse foundation. Alternatively, the system design tool may be developed using C or C++. Other programming languages suitable for developing a design tool may also be used to develop the system design tool.

Controller 22 may include devices suitable for running a software program. These devices may include, for example, a CPU, RAM, and I/O modules. In one embodiment, controller 22 may constitute a unit dedicated for designing systems based on a user input. Alternatively, controller 22 may be integrated with and/or correspond to another control unit (not shown) that may perform other functions in addition to those required by system design environment 10.

The system specification output of controller 22 may exist in various forms. For example, if controller 22 used a number of software assets from RAS based database 24 to form the specification, the output may include one or more software files that are a combination of the software assets chosen from RAS based database 24. Alternatively, if controller 22 used a number of hardware assets from RAS based database 24 to form the specification, the output may include a number of block diagrams displaying the chosen hardware assets linked to each other. In an exemplary embodiment, the output may include a combination of software files and block diagrams.

Output device 26 may include means for outputting a specification for a user. In some exemplary embodiments, the specification may be output on a screen monitor. Alternatively, or in addition, the specification may be output to a printer. In other exemplary embodiments, the specification may be output on a computer-readable medium. The computer-readable medium may include an optical storage device, a magnetic storage device, a CD-ROM, a DVD, a floppy disk, a hard disk, a flash memory device, a magnetic card, and/or a tape drive. In addition, other mediums capable of storing the system specification may be used as output device 26.

The specification that is output by controller 22 on output device 26 may include two or more hardware components linked together. This linking may be done on a computer where graphical representations of the hardware components are joined together to form a computer model of the system. Alternatively, the hardware components may be linked together by linking block diagram representations of the hardware components together. In other embodiments, the specification may include two or more software components linked together. In these embodiments, the software components may be linked together by compiling them as one piece of code. In addition, other means for linking components together may be used to link hardware components together and software components together.

An alternative exemplary embodiment consistent with the present disclosure may include a computer readable medium including instructions for any computer to accept a user input that may include at least one desired parameter. The computer readable medium may also include instructions to access RAS based database 24 including hardware component information. Furthermore, the computer readable medium may include instructions for identifying from RAS based database 24 at least one hardware component that contributes to satisfaction of the desired system parameter. The computer readable medium may also include instructions to output a specification for a system including the at least one hardware component. The computer readable medium may also include similar instructions relating to software components stored in RAS based database 24. The computer readable medium that stores these instructions may exist in various forms. For example the medium may include an optical storage device, a magnetic storage device, a CD-ROM, a DVD, a floppy disk, a hard disk, a flash memory device, a magnetic card, and/or a tape drive. In addition, any other medium capable of storing these instructions may be used to store the above-mentioned instructions.

### INDUSTRIAL APPLICABILITY

Controller 22 may identify from RAS based database 24, hardware and/or software assets that may be used to satisfy the system parameter desired by the user. The structure of RAS database 24 may make the identification process more efficient. For example, if controller 22 is being used to design a track-type tractor and is searching for a hardware asset 160 to help control the regeneration of a particulate trap in the track-type tractor, then the name/value pairs in classification section 162 of a hardware asset that include domain “regeneration” may be made available to controller 22. The hardware asset may, for example, be a regeneration controller. In addition, information pertaining to whether the hardware asset is reusable, which is also included in classification section 162, may also be made available to controller 22. Furthermore, information about the various artifacts that make up this hardware asset (e.g., the type of processor chip and memory chip used in the regeneration controller), included in solution selection 164, may be made available to controller 22. Usage section 166 of hardware asset 160 may provide controller 22 with information about the reusage cost of the hardware asset. Based on this information, controller 22 may determine whether or not to use the hardware asset in its specification for the system.

The disclosed method and system for designing a system using a RAS database may be used to design any system that includes components for which information may be stored in a RAS database. The disclosed system may allow a developer of an asset to include all the information relevant to the asset in the RAS database. For example, the developer may add information about the rules followed in developing the asset, the development hours and the reusage hours pertaining to the asset. This information may help a user reuse the asset. This reusage of existing assets may help reduce the number of hours spent in developing a system. It may also prevent duplication of efforts because another group may use an asset that has already been developed by one group.

The use of a RAS based database to categorize components may be advantageous because RAS is an industry standard, and therefore, the information requirement for the components may be standardized. This standardization may simplify the adding of different products to the catalog. For example, all developers in an entity may be asked to provide the same kind of information for the different assets they may develop, in order for the assets to be added to the RAS based database. This promotes uniformity of the kind of information available for all assets developed by the entity regardless of the actual differences between the components themselves. Furthermore, this standardization may also allow an entity to add assets manufactured by entities outside of a user organization. Being able to add assets made by entities unrelated to the one using the RAS based database/catalog may allow for a greater number of assets to be added to a database.

The disclosed method and system may also allow for storing hardware asset information in the RAS based database. This storage of hardware asset information in the RAS based database may allow a system design environment to output not only a software specification for a system, but may also allow output of a hardware specification instead of, or in addition to, the software specification.

It will be apparent to those skilled in the art that various modifications and variations can be made in the disclosed system without departing from the scope of the disclosure. Additionally, other embodiments of the disclosed system will be apparent to those skilled in the art from consideration of the specification. It is intended that the specification and the examples be considered exemplary only, with a true scope of the disclosure being indicated by the following claims and their equivalents.

What is claimed is:

1. A system design environment comprising:
a Reusable Asset Specification (“RAS”) based database including information related to hardware components;
a controller configured to:
accept a user input including at least one desired system parameter;
identify from the RAS based database, at least one hardware component that contributes to satisfaction of the desired system parameter; and
output a specification for a system including the at least one hardware component.

2. The design environment of claim 1, wherein the controller is further configured to link two or more hardware components together when the two or more hardware components are identified.

3. The design environment of claim 1, wherein the RAS based database includes information related to components developed by entities outside of a user organization.

4. The design environment of claim 1, wherein the RAS based database is developed using a plurality of programming languages and at least one of the plurality of programming languages includes Extensible Markup Language (“XML”).

5. The design environment of claim 1, wherein the RAS based database further includes information related to software components.

6. The design environment of claim 5 further including a controller configured to:
accept a user input including at least one desired system parameter;
identify from the RAS based database, at least one software component that contributes to satisfaction of the desired system parameter; and
output a specification for a system including the at least one software component.

7. The design environment of claim 6, wherein the controller is further configured to link two or more software components together when the two or more software components are identified.

8. The design environment of claim 5, wherein the RAS based database includes at least one of a default profile and a related profile for the hardware and software components, wherein the related profile includes characteristics included in the default profile.

9. The design environment of claim 8, wherein the related profile includes at least one of a software profile, a system profile, and a hardware profile.

10. The design environment of claim 8, wherein the default profile and the related profile include a plurality of sections configured to store information about the hardware and software components.

11. The design environment of claim 10, wherein the plurality of sections include a classification section, a solution section, a usage section, and a related section.

12. The design environment of claim 10, wherein the RAS based database includes one or more contexts in which the hardware and software components may be used, the one or more contexts being based on the information stored in the plurality of sections.

13. A method of designing a system comprising:
accepting a user input including at least one desired system parameter;
accessing a Reusable Asset Specification (“RAS”) database including hardware component information;
identifying, from the RAS database, at least one hardware component that contributes to satisfaction of the desired system parameter; and
outputting a specification for a system including the at least one hardware component.

14. The method of claim 13 further including linking two or more hardware components together when the two or more hardware components are identified.

15. The method of claim 13, wherein the RAS database includes information for components developed by entities outside of a user organization.

16. The method of claim 13, wherein the RAS database is developed using a plurality of programming languages and at least one of the plurality of programming languages includes Extensible Markup Language (“XML”).

17. The method of claim 13, wherein the RAS database further includes software component information.

18. The method of claim 17 further including:
accepting a user input including at least one desired system parameter;
accessing the RAS database including software component information;
identifying, from the RAS database, at least one software component that contributes to satisfaction of the desired system parameter; and
outputting a specification for a system including the at least one software component.

19. The method of claim 18 further including linking two or more software components together when the two or more software components are identified.

20. The method of claim 17, wherein the RAS database includes at least one of a default profile and a related profile for the hardware and software components, wherein the related profile includes characteristics included in the default profile.

21. The method of claim 20, wherein the related profile includes at least one of a software profile, a system profile, and a hardware profile.

22. The method of claim 20, wherein the default profile and the related profile include a plurality of sections configured to store information about the hardware and software components.

23. The method of claim 22, wherein the plurality of sections include a classification section, a solution section, a usage section, and a related section.

24. The method of claim 22, wherein the RAS database includes one or more contexts in which the hardware and software components may be used, the one or more contexts being based on the information stored in the plurality of sections.

25. A computer readable medium including instructions for:
accepting a user input including at least one desired system parameter;
accessing a Reusable Asset Specification (“RAS”) database including hardware component information;
identifying, from the RAS database, at least one hardware component that contributes to satisfaction of the desired system parameter; and
outputting a specification for a system including the at least one hardware component.

26. The computer readable medium of claim 25, wherein the RAS database further includes software component information.

27. The computer readable medium of claim 26, further including instructions for:
accepting a user input including at least one desired system parameter;
accessing the RAS database including software component information;
identifying, from the RAS database, at least one software component that contributes to satisfaction of the desired system parameter; and
outputting a specification for a system including the at least one software component.
